(19) United States
(12) Patent Application Publication
(10) Pub. No.: US 2026/0335775 A1
(43) Pub. Date: Oct. 29, 2026

(54) PROGRAM, METHOD, AND SYSTEM

(71) Applicant: CYGAMES, INC., Tokyo (JP)

(72) Inventors: Naoyuki Miyashita, Tokyo (JP); Daisuke Yamanaka, Tokyo (JP); Tomoki Motohashi, Tokyo (JP); Yamato Nanba, Tokyo (JP); Kenta Ashizawa, Tokyo (JP); Masaya Kamachi, Tokyo (JP)

(73) Assignee: CYGAMES, INC., Tokyo (JP)

(21) Appl. No.: 19/698,495

(22) Filed: Jun. 4, 2026

Related U.S. Application Data
(63) Continuation of application No. PCT/JP2024/043226, filed on Dec. 6, 2024.

(30) Foreign Application Priority Data
Dec. 8, 2023 (JP) 2023-208098

(51) Int. Cl. A63F 13/822; A63F 13/52; A63F 13/533; A63F 13/537

(52) U.S. Cl. CPC A63F 13/822; A63F 13/52; A63F 13/533; A63F 13/537

(57) ABSTRACT

A program as an example of the present disclosure is a program for providing a battle game in which a plurality of players compete with each other on a turn basis using a deck including a plurality of game contents, the program causing at least one computer to execute determining a play order of the plurality of players in the battle game, granting a right to generate a game effect for causing the battle to progress more advantageously to a first player in a first play order than to a second player in a second play order earlier than the first play order, generating the game effect in accordance with a first operation of the first player, and canceling generation of the game effect in accordance with the first operation in accordance with a second operation of the first player.

### TECHNICAL FIELD

The present disclosure relates to a program, a method, and a system.

### BACKGROUND ART

In the related art, a technology of providing a user with a battle game using a deck including a predetermined number of pieces of game content selected from among a plurality of pieces of game content (for example, digital cards) each of which is associated with an attribute is known.

### CITATION LIST

### Patent Literature

Patent Document 1: JP 6804675 B

### SUMMARY OF INVENTION

### Technical Problem

In general, in the above-described battle game, an action order is assigned to a plurality of players playing the battle game, such as first attack/second attack. There is a demand for further improving the enjoyment of the battle game by reducing the advantage/disadvantage according to the action order.

Accordingly, in order to solve one of the problems, an object of the present disclosure is to provide a program, a method, and a system capable of further enhancing the appeal of a battle game.

### Solution to Problem

A program as an example of the present disclosure is a program for providing a battle game in which a plurality of players each battle in a turn-based battle using a deck including a plurality of pieces of game content that causes at least one computer to execute: determining a play order of the plurality of players in the battle game; granting, to a first player with a first play order, a right to generate a game effect for causing the battle to progress more advantageously than a second player with a second play order before the first play order; generating a game effect in response to a first operation of the first player; and canceling generation of the game effect in accordance with the first operation in response to a second operation of the first player.

A method as another example of the present disclosure is a method executed by at least one computer of providing a battle game in which a plurality of players each battle in a turn-based battle using a deck including a plurality of pieces of game content, the method including: determining a play order of the plurality of players in the battle game; granting, to a first player with a first play order, a right to generate a game effect for causing the battle to progress more advantageously than a second player with a second play order before the first play order; generating a game effect in response to a first operation of the first player; and canceling generation of the game effect in accordance with the first operation in response to a second operation of the first player.

A system as yet another example of the present disclosure is a system for providing a battle game in which a plurality of players each battle in a turn-based battle using a deck including a plurality of pieces of game content, the system being configured to: determine a play order of the plurality of players in the battle game; grant, to a first player with a first play order, a right to generate a game effect for causing the battle to progress more advantageously than a second player with a second play order before the first play order; generate a game effect in response to a first operation of the first player; and cancel generation of the game effect in accordance with the first operation in response to a second operation of the first player.

### BRIEF DESCRIPTION OF DRAWINGS

FIG. 1 is an exemplary and schematic diagram illustrating a configuration of a system according to an embodiment.

FIG. 2 is an exemplary and schematic block diagram illustrating a functional configuration of a terminal apparatus according to the embodiment.

FIG. 3 is an exemplary and schematic sequence diagram illustrating a procedure of processing that is executed by the terminal apparatus and a server apparatus according to the embodiment.

FIG. 4 is an exemplary and schematic sequence diagram illustrating an example of the procedure of granting a right according to an action order in the game execution processing according to the embodiment.

FIG. 5 is an exemplary and schematic diagram illustrating an example of a battle screen according to the embodiment.

FIG. 6 is an exemplary and schematic diagram for describing in detail the own PP (play points) display region according to the embodiment.

FIG. 7 is an exemplary and schematic diagram for describing in detail the other PP display region according to the embodiment.

FIG. 8 is an exemplary and schematic flowchart illustrating an example of a procedure of PP management processing that is executed by the server apparatus according to the embodiment.

FIG. 9 is an exemplary and schematic block diagram illustrating an example of a hardware configuration of an information processing apparatus including the terminal apparatus and the server apparatus according to the embodiment.

### DESCRIPTION OF EMBODIMENTS

Hereinafter, embodiments of a program, a method, and a system according to the present disclosure will be described with reference to the drawings. The configurations of the embodiments, which will be described below, and functions and effects provided by the configurations are merely examples and are not limited to the following description.

In addition, although ordinal numbers such as “first” and “second” are used as necessary in the following description, these ordinal numbers are used for convenience of identification and do not indicate specific priorities.

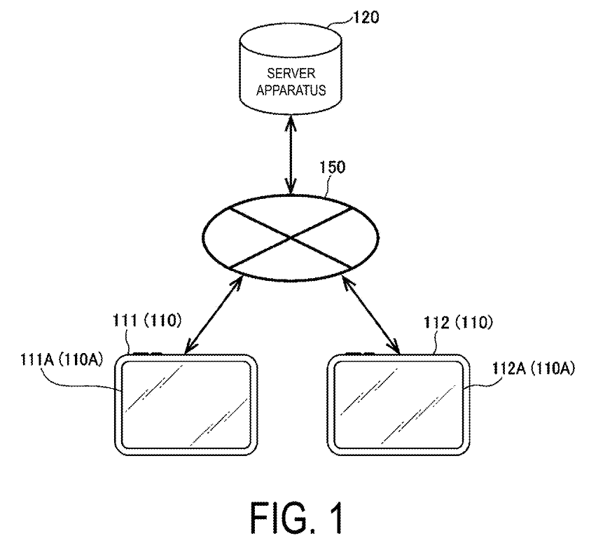

FIG. 1 is an exemplary and schematic diagram illustrating a configuration of a system according to an embodiment.

As illustrated in FIG. 1, the system according to the embodiment includes a plurality of terminal apparatuses 110 each of which includes a display 110A including a touch panel and a server apparatus 120. The terminal apparatus 110 and the server apparatus 120 are communicably connected to each other via a network 150 such as the Internet.

Note that the configuration illustrated in FIG. 1 is merely an example and does not limit the technical idea of the present disclosure. For example, FIG. 1 illustrates terminal apparatuses 111 and 112 configured as tablet computers respectively including displays 111A and 112A as examples of the terminal apparatus 110 including the display 110A. However, the number of terminal apparatuses 110 may be three or more, and the terminal apparatus 110 may be configured as an electronic device other than the tablet computer as long as the terminal apparatus has a configuration equivalent to that of a general computer (a specific example will be described later with reference to FIG. 12).

With the configuration described above, in the embodiment, a battle game is provided between users of the terminal apparatuses 110 via the network 150. For example, in the embodiment, the battle game is a turn-based battle game using a deck including a predetermined number of cards selected from, for example, digital cards (hereinafter, simply referred to as cards) as a plurality of pieces of game content each of which is associated with an attribute (hereinafter, referred to as a class). In the embodiment, in the progression of the battle game, first, the play order of a plurality of players (two players in the following example, but there may be three or more players) who battle each other is determined, and after the battle game has started, the battle game progresses in the form of each player taking their turn in order according to the determined play order. On their turn, each player can play a piece of game content by appropriately consuming play points (points necessary for playing a piece of game content on a turn, and hereinafter, this may be simply referred to as PP) set in advance for each turn.

For example, in the embodiment, the user of each terminal apparatus 110 owns cards provided by the administrator of the battle game by digitally acquiring the cards by lottery or the like, builds a deck by selecting a predetermined number of cards from the cards that the user owns in consideration of the classes, and plays the battle game with other users via the server apparatus 120 by using the built deck.

In addition, in the embodiment, the server apparatus 120 records, for example, player information regarding a user (player) who plays a battle game for each user who participates in the battle game. Examples of the player information include information related to cards owned by the player, information related to decks built by the player in the past, and the like. Then, the server apparatus 120 updates the recorded player information or controls the progress of the battle game based on information output from the terminal apparatus 110 in accordance with an operation of the user.

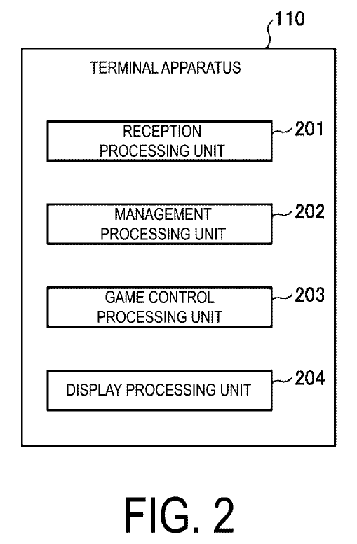

FIG. 2 is an exemplary and schematic block diagram illustrating a functional configuration of the terminal apparatus 110 according to the embodiment.

As illustrated in FIG. 2, the terminal apparatus 110 includes a reception processing unit 201, a management processing unit 202, a game control processing unit 203, and a display processing unit 204.

The reception processing unit 201 receives inputs of various operations of the user who uses the terminal apparatus 110. For example, the reception processing unit 201 receives selection of a format of the battle game (battle format) before the battle game is started, receives selection of a class of cards to be included in a deck to be used in the battle game, and receives selection of the cards to be included in the deck after the class is selected.

The management processing unit 202 manages the deck built in accordance with the operations of the user. For example, the management processing unit 202 may manage a group identifier of pieces of game content that can be included in the deck, based on the format selected by the user.

The game control processing unit 203 controls the progress of the battle game in cooperation with the server apparatus 120 through communication. Further, the display processing unit 204 controls output of an image related to the battle game to the display 110A.

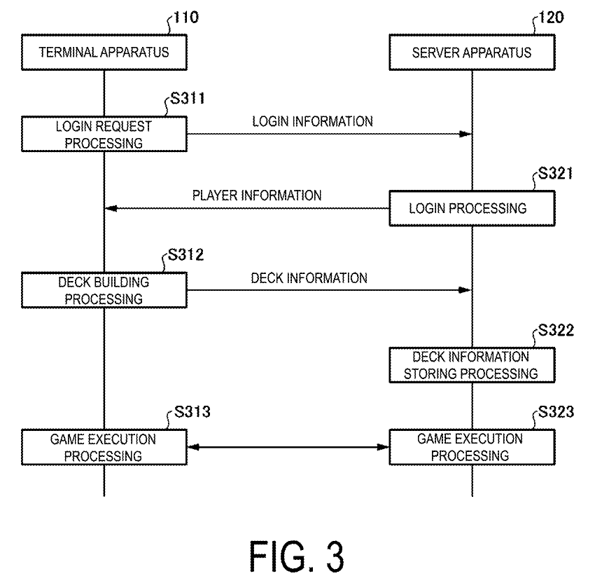

Based on the functional configuration as described above, the terminal apparatus 110 according to the embodiment executes various processing in cooperation with the server apparatus 120 in accordance with a procedure as illustrated in FIG. 3, which will be described below, when providing the battle game to the user.

FIG. 3 is an exemplary and schematic sequence diagram illustrating a procedure of processing that is executed by the terminal apparatus 110 and the server apparatus 120 according to the embodiment.

As illustrated in FIG. 3, in the embodiment, the terminal apparatus 110 (for example, the game control processing unit 203) first performs login request processing for acquiring player information of the user of the terminal apparatus 110 from the server apparatus 120 in S311 and transmits login information including identification information of the user and the like to the server apparatus 120. The processing in S311 is performed, for example, when an application installed in the terminal apparatus 110 is started to provide the battle game.

Then, the server apparatus 120 performs login processing based on the login information received from the terminal apparatus 110 in S321, extracts the corresponding player information from player information recorded by the server apparatus 120, and transmits the extracted player information to the terminal apparatus 110.

Then, the terminal apparatus 110 (for example, the reception processing unit 201, the management processing unit 202, and the display processing unit 204) performs deck building processing of building a deck to be used in the battle game in response to an operation of the user in S313 and transmits deck information regarding the built deck to the server apparatus 120. As will be described in detail later, the deck building processing is processing of managing the deck by the management processing unit 202 while receiving the operation of the user by the reception processing unit 201 and displaying various images (screens) on the display 110A by the display processing unit 204 as necessary.

Then, the server apparatus 120 performs, in S322, deck information storing processing of storing the deck information received from the terminal apparatus 110 and updating the player information recorded in the server apparatus 120.

Then, the terminal apparatus 110 (for example, the reception processing unit 201, the game control processing unit 203, and the display processing unit 204) and the server apparatus 120 perform game execution processing of executing the battle game in cooperation with each other through communication in S313 and S323, respectively. The game execution processing is processing of controlling the progress of the game by the game control processing unit 203 while receiving the operation of the user by the reception processing unit 201 and displaying various images (screens) on the display 110A by the display processing unit 204.

In the above-described battle game, an action order is assigned to a plurality of players playing the battle game, such as first attack/second attack. There is a demand for further improving the enjoyment of the battle game by reducing the advantage/disadvantage according to the action order.

Thus, in the embodiment, in the game execution processing of S323 described above, the server apparatus 120 takes the initiative to determine the play order of the plurality of players in the battle game and to grant the right to generate a game effect for allowing a first player with a first play order (in the case of a two-player battle, the player who is the second attacker) to progress through the battle more advantageously than a second player with a second play order that comes before the first play order (in the case of a two-player battle, the player who is the first attacker).

The granting of the right is executed at the start of the battle, more specifically, after processing of giving one or more pieces of initial game content that can be played from among a plurality of pieces of game content included in a deck to each of the first player and the second player. Initial game content is game content given to each player as game content that can be used from the beginning of the battle.

The game effect generated by this right is, for example, an effect that is not associated with the initial game content and is an effect of temporarily increasing the PP described above corresponding to the points set for each turn that decrease in accordance with game content being played in the battle. The PP increased by the game effect (hereinafter, this may be expressed as an extra PP) is a PP that can be used (consumed) only once during the battle before a predetermined condition (described later in detail) under which the game effect cannot be cancelled is satisfied, and when the predetermined condition is satisfied, the PP cannot be used thereafter (the right itself cannot be used). Note that in the following, only examples in which the game effect generated by the right is an effect that temporarily increases the PP are described. However, in the embodiment, a right that generates a different effect can be used. Other conceivable examples of a right to generate a different effect include, for example, a right to strengthen a piece of game content that has been played (an evolution right), a right to extend a time limit when determining a piece of game content to be played (a long-thought right), and the like.

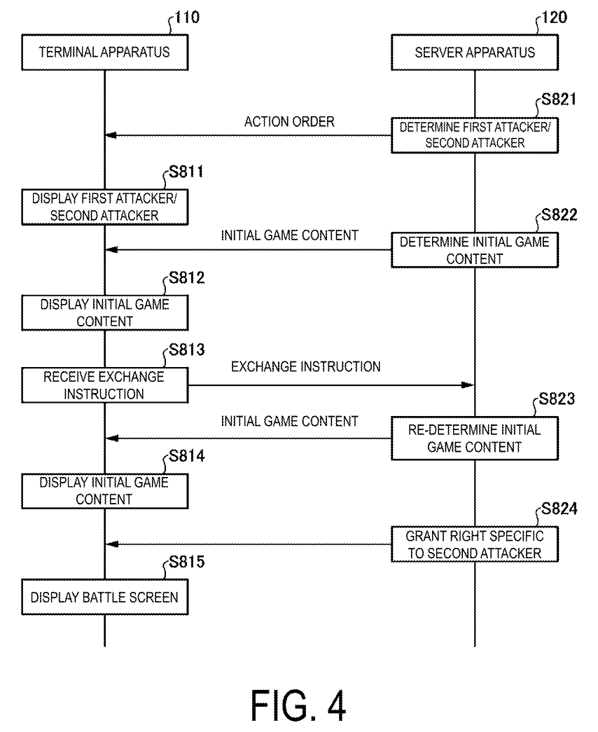

Here, the procedure of the above-described granting of the right will be described with reference to FIG. 4.

FIG. 4 is an exemplary and schematic sequence diagram illustrating an example of the procedure of granting a right according to an action order in the game execution processing according to the embodiment. The procedure of processing illustrated in FIG. 4 is executed at the start of the battle as described above.

As illustrated in FIG. 4, in the embodiment, first in S821, the server apparatus 120 determines the action order (for example, first attack or second attack) of each player in the battle and notifies the terminal apparatus 110 of each player of the determined action order. Then, in the S811, the terminal apparatus 110 displays the action order (for example, the first attack or second attack) notified from the server apparatus 120 on the display 110A.

Then, in S822, the server apparatus 120 determines the initial game content to be given to each player in the battle by a lottery from the deck of each player and notifies the terminal apparatus 110 of each player of the determined initial game content. Then, in the S812, the terminal apparatus 110 displays the initial game content notified from the server apparatus 120 on the display 110A.

Here, in the battle game according to the embodiment, a part or all of the initial game content may be set to be exchanged only once by an instruction of each player. Thus, in S813, the terminal apparatus 110 may receive an initial game content exchange instruction from the player and notify the server apparatus 120 of the received exchange instruction.

Then, in S823, when the server apparatus 120 receives the exchange instruction from the terminal apparatus 110, the server apparatus 120 re-determines the initial game content by redoing the lottery from the deck of each player and notifies the terminal apparatus 110 of each player of the re-determined initial game content. Then, in S814, the terminal apparatus 110 displays the initial game content (redetermined initial game content) notified from the server apparatus 120 on the display 110A. In the embodiment, when there is no instruction to exchange the initial game content from the player, the processing of S813, S823, and S814 are skipped.

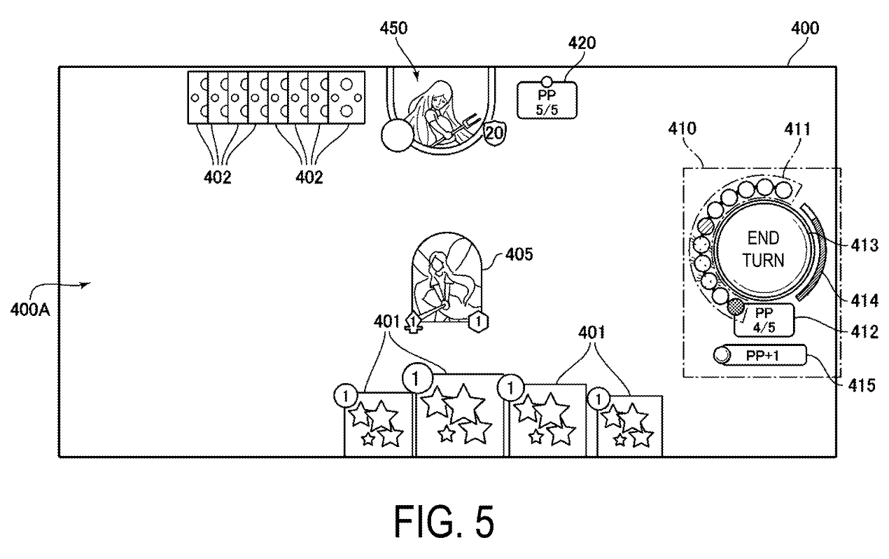

In S824, the server apparatus 120 grants the second attacker a right specific to the second attacker, more specifically, the right to generate a game effect that allows the player to progress through the battle more advantageously than the first attacker, and notifies the terminal apparatus 110 of the second attacker of the granted right. Then, in S815, the terminal apparatus 110 displays a battle screen as illustrated in FIG. 5 on the terminal apparatus 110.

FIG. 5 is an exemplary and schematic diagram illustrating an example of the battle screen according to the embodiment.

An image 400 illustrated in FIG. 5 is an example of a battle screen displayed on the terminal apparatus 110 of the second attacker when a battle between two players is started. The image 400 includes a region 410 corresponding to an own PP information display region in which information related to the player’s own PP is displayed and a region 420 corresponding to an other PP information display region in which information related to the play points of the opponent is displayed. The region 410 corresponding to the own PP display region includes images 411 and 412 as PP display regions, an image 413 corresponding to an end turn button, an image 414 corresponding to a timer gauge that changes with time so as to indicate the time limit of each turn, and an image 415 corresponding to a use second attacker right button.

The image 400 illustrated in FIG. 4 includes images 401 indicating game content that can be used (played) by the user in the battle at the current time and images 402 indicating game content that can be used by the opponent in the battle at the current time. In the battle game according to the embodiment, when each player plays a piece of game content on each turn, an image corresponding to the piece of game content is displayed in a game field 401A provided in the image 400. The image is displayed indicating a parameter that indicates the strength (for example, an attack power, a defense power, or the like) set in advance for the corresponding piece of game content. For example, in the example illustrated in FIG. 4, an image 405 corresponding to a predetermined piece of game content that the user has played is displayed in a game field 400A, and the image 405 indicates that the attack power and the defense power set for the corresponding piece of game content are 1.

In the embodiment, on each turn, parameters indicating the strength (for example, attack power, defense power, and the like) set in advance for (pieces of game content of each player corresponding to) images displayed in the game field 401A are compared to determine the winner between pieces of game content, and as a result, the battle game progresses with whether each player on each turn is winning or losing being determined on the game field 401A.

In addition to the above, the image 400 illustrated in FIG. 4 includes a region 450 in which a character or the like indicating an opponent is displayed on the opponent side (that is, on the upper side of the image 400). In this region 450, a numerical value (20 in the example illustrated in FIG. 4) indicating the health of the opponent is also displayed. In the embodiment, the battle game progresses with the aim of ultimately reducing the health of the opponent to zero using the game content played onto the game field 401A. Note that, although not illustrated in the example illustrated in FIG. 4 due to being hidden by the images 401, the image 400 may include a region similar to the region 450 described above in which a character indicating the user is displayed on the user side (that is, on the lower side of the image 400).

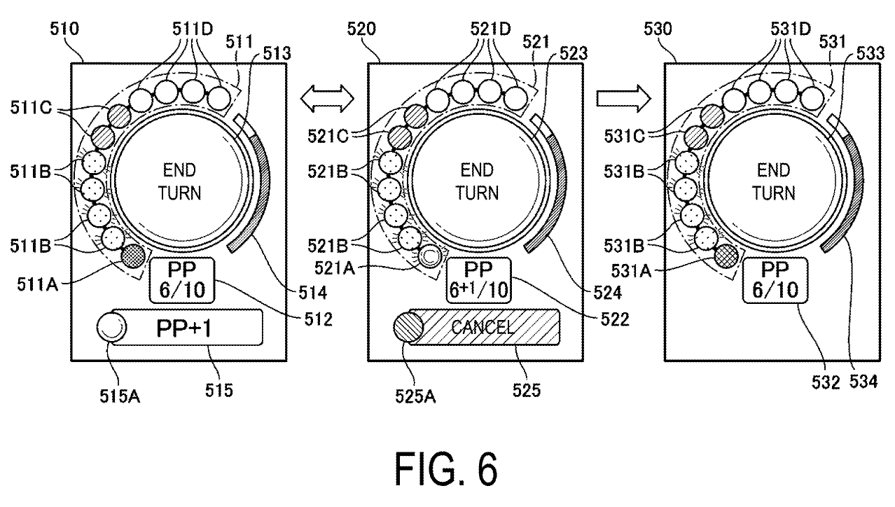

Here, the above-described own PP display region will be described in more detail with reference to FIG. 6.

FIG. 6 is an exemplary and schematic diagram for describing in detail the own PP display region according to the embodiment.

The example illustrated in FIG. 6 illustrates the transitions of the own PP display region according to the state of the right granted to the second attacker. In the example illustrated in FIG. 6, an image 510 on the left side indicates the own PP display region in a state where the granted right has not yet been used, an image 520 in the middle illustrates the own PP display region in a state where the granted right is used, and an image 530 on the right side illustrates the own PP display region in a state where the granted right has already been used and has become unusable.

In the image 510 on the left side, images 511 and 512 are PP display regions. In the embodiment, as seen in the image 511, the information relating to the PP of the current turn is displayed with the following modes being visually distinct from one another: additional PP that can be increased based on the right granted to the second attacker (see image 511A), PP that can be consumed in the current turn (see image 511B), PP that has already been consumed in the current turn (see image 511C), and PP that cannot be consumed until the next turn or later (see image 511D). In the embodiment, as seen in an image 512, the information relating to the PP of the current turn is also displayed as text information.

In the image 510 on the left side, an image 513 is an end turn button, and an image 514 is a timer gauge. The player can pass the turn to their opponent (that is, end their turn and, as a result, start the turn of their opponent) by pressing the end turn button such as the image 513. Further, the player can check the remaining time of their turn, for example, by checking the timer gauge such as the image 514.

In the image 510 on the left side, an image 515 is a use second attacker right button. By pressing the use second attacker right button such as the image 515, the player can use the right described above granted due to being the second attacker and can generate a game effect of temporarily increasing the PP. The image 515 includes a region 515A with a display mode (for example, lighting state) that changes according to the state of the right. As described above, in the embodiment, when the right granted to the second attacker has not yet been used, the use second attacker right button is displayed in a display mode that allows an operation to use the right to be received.

Note that when the use second attacker right button is pressed on the image 510 on the left side described above, the image 510 transitions to the image 520 in the middle as will be described below.

In the image 520 in the middle, images 521 and 522 are PP display regions. In the embodiment, as seen in the image 521, the information relating to the PP of the current turn is displayed with the following modes being visually distinct from one another: additional PP that can be increased based on the right granted to the second attacker (see image 521A), PP that can be consumed in the current turn (see image 521B), PP that has already been consumed in the current turn (see image 521C), and PP that cannot be consumed until the next turn or later (see image 521D). In the embodiment, as seen in an image 522, the information relating to the PP of the current turn is also displayed as text information. As described above, since the state in which the image 520 in the middle is displayed is a state in which the granted right has been used, the region 525A is displayed in a different mode from the region 515A corresponding to the image 510 on the left side indicating the state in which the granted right has not been used yet.

In the image 520 in the middle, an image 523 is an end turn button and an image 524 is a timer gauge. The player can pass the turn to their opponent (that is, end their turn and, as a result, start the turn of their opponent) by pressing the end turn button such as the image 523. Further, the player can check the remaining time of their turn, for example, by checking the timer gauge such as the image 524.

In the image 520 in the middle, an image 525 is a use second attacker right button. The player can cancel the generation of the game effect according to the operation of the image 515 of the image 510 on the left side by pressing the use second attacker right button such as the image 525. The image 525 includes a region 525A with a display mode (for example, lighting state) that changes according to the state of the right. When the generation of the game effect is canceled by the image 525 being pressed, the image 520 in the middle transitions to the image 510 on the left side.

As described above, in the embodiment, when the operation of using the right granted to the second attacker is received via the image 510 on the left side and a predetermined condition under making the game effect unable to be canceled is not satisfied, the image 520 in the middle including the use second attacker right button displayed in the display mode in which the operation of canceling the generation of the game effect according to the specification of the right can be received is displayed. The predetermined condition that makes the game effect unable to be cancelled is, for example, a case where one or more PPs are consumed in response to the operation of a piece of game content, a case where the end turn button is pressed in a state where the game effect according to the use of the right granted to the second attacker has been generated, or the like.

Here, when the end turn button (see the image 523) is pressed in a state where the image 520 in the middle is displayed, the image 520 in the middle transitions to the image 530 on the right side as described below.

In the image 530 on the right side, images 531 and 532 are PP display regions. In the embodiment, as seen in the image 531, the information relating to the PP of the current turn is displayed with the following modes being visually distinct from one another: additional PP that can be increased based on the right granted to the second attacker (see image 531A), PP that can be consumed in the current turn (see image 531B), PP that has already been consumed in the current turn (see image 531C), and PP that cannot be consumed until the next turn or later (see image 531D). In the embodiment, as seen in an image 532, the information relating to the PP of the current turn is also displayed as text information. As described above, since the state in which the image 530 on the right side is displayed is a state in which the granted right has already been used and is unusable, the region 531A is displayed in a different mode from the image 511A corresponding to the image 510 on the left side and the image 521A corresponding to the image 520 in the middle.

In the image 530 on the right side, an image 533 is an end turn button, and an image 534 is a timer gauge. The player can pass the turn to their opponent (that is, end their turn and, as a result, start the turn of their opponent) by pressing the end turn button such as the image 533. Further, the player can check the remaining time of their turn, for example, by checking the timer gauge such as the image 534.

As described above, the state in which the image 530 on the right side is displayed is a state in which the right is unusable due to the turn being ended after the granted right was used, and more specifically, either a state in which the turn has ended after the extra PP was granted and then used to play a piece of game content or a state in which the extra PP has been granted but the turn was ended without the extra PP being used (including a case where the granted extra PP was canceled). Thus, the image 530 on the right side is different from the image 510 on the left side and the image 520 in the middle with the use second attacker right button being hidden. At this time, the image 531A indicating the additional PP (extra PP) may also be displayed. In addition, in the embodiment, for example, when the original PP is increased by the extra PP, the extra PP is used in preference to the original PP.

In the embodiment, when the extra PP is used (that is, a piece of game content is played) after the extra PP has been granted in response to the use of the granted right, before the end turn button is pressed, the display mode of the image 520 in the middle may be switched to a display mode indicating that the game effect cannot be cancelled (for example, a state in which the use second attacker right button indicated by the image 525 cannot be pressed, and a mode in which the display of the region 525A in the image 525 disappears). When the end turn button is pressed in this state, the display is switched to the image 530 on the right side. In the embodiment, when the extra PP is used after the extra PP has been granted in response to the use of the granted right, the display may be switched to the image 530 on the right side regardless of whether the end turn button has been pressed.

In the above-described example, a configuration is illustrated in which, when the player is the second attacker and the opponent is the first attacker, information relating to the right of the player granted due to the fact that the player is the second player is displayed on the player's battle screen (own PP display region). However, in the embodiment, as illustrated in FIG. 6, when the player is the first attacker and the opponent is the second attacker, information relating to the right granted to the opponent can be displayed on the player's battle screen (other PP display region).

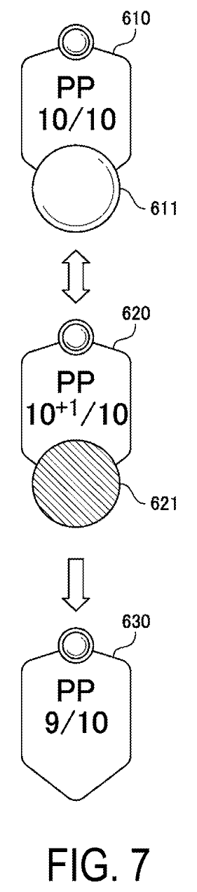

FIG. 7 is an exemplary and schematic diagram for describing in detail the other PP display region according to the embodiment.

The example illustrated in FIG. 7 illustrates transitions of the other PP display region displayed on the terminal apparatus 110 of the player according to the state of the right granted to the opponent when the player is the first attacker and the opponent is the second attacker (transitions of the other PP display region displayed on the terminal apparatus 110 of the opponent according to the state of the right granted to the player when the player is the second attacker and the opponent is the first attacker). In the example illustrated in FIG. 7, an image 610 on the upper side indicates the own PP display region in a state where the granted right has not yet been used, an image 620 in the middle illustrates the own PP display region in a state where the granted right is used, and an image 630 on the lower side illustrates the own PP display region in a state where the granted right has already been used and has become unusable.

The image 610 on the upper side includes a region 611 with a display mode (for example, lighting state) that changes according to the state of the right of the opponent. In a state where the image 610 on the upper side is displayed, when the opponent uses the right of the second attacker, the image 610 transitions to the image 620 in the middle as described below.

The image 620 in the middle includes a region 621 with a display mode (for example, lighting state) that changes according to the state of the right of the opponent. As described above, since the state in which the image 620 in the middle is displayed is a state in which the granted right has been used, the region 621 is displayed in a different mode from the region 611 indicating the state in which the granted right has not been used yet.

When the generation of the game effect is canceled in a state in which the image 620 in the middle is displayed, the image 620 in the middle transitions to the image 610 on the upper side. Also, in a state where the image 620 in the middle is displayed, when the game effect becomes unable to be canceled, that is, when the right of the second attacker granted to the opponent has already been used and cannot be used, the image 620 in the middle transitions to the image 630 on the lower side as described below.

The image 630 on the lower side does not include a region corresponding to the region 611 of the image 610 on the upper side and the region 621 of the image 620 in the middle. This is because the image 630 on the lower side clearly shows the player that the right of the second attacker granted to the opponent has already been used and is unusable because the game effect has become unable to be cancelled.

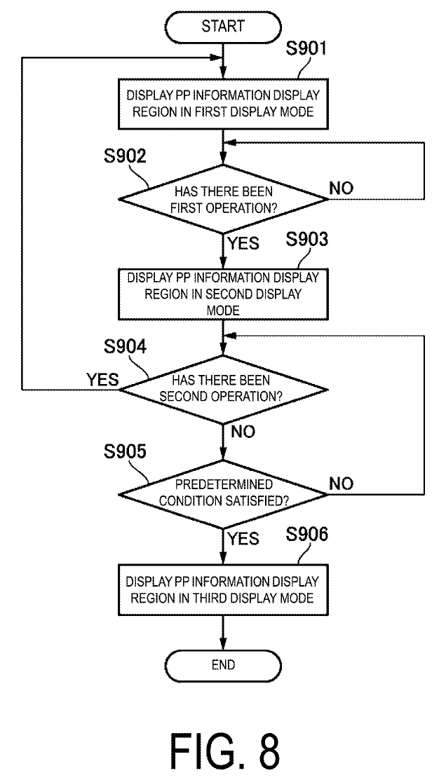

The transitions of the PP display regions (the own PP display region and the other PP display region) as described above are executed based on the management of the PP of each player on the server apparatus 120 side as illustrated in FIG. 8 as follows, for example.

FIG. 8 is an exemplary and schematic flowchart illustrating an example of a procedure of PP management processing that is executed by the server apparatus 120 according to the embodiment. The following processing is executed when it is determined that it is the turn of a player granted with extra PP and the extra PP is in a usable state. This determination is executed by the server apparatus 120.

As illustrated in FIG. 8, in the embodiment, first, in S901, the server apparatus 120 outputs an instruction to the terminal apparatus 110 to display the PP display region in a first display mode in S901. The instruction to the terminal apparatus 110 of the player who is the second attacker is for displaying the own PP display region in a display mode such as the image 510 on the left side of FIG. 6 (an example of a “first display mode” in the claims), and the instruction to the terminal apparatus 110 of the player who is the first attacker is for displaying the other PP display region in a display mode such as the image 610 on the upper side of FIG. 7.

Then, in S902, the server apparatus 120 determines whether a first operation (operation of using the right specific to the second attacker) has been received via the terminal apparatus 110 of the second attacker. The processing of S902 is repeated until it is determined that the first operation has been received. Then, in S902, when it is determined that the first operation has been received, the processing proceeds to S903.

Then, in S903, the server apparatus 120 outputs an instruction to the terminal apparatus 110 to display the PP display region in a second display mode. The instruction to the terminal apparatus 110 of the player who is the second attacker is for displaying the own PP display region in a display mode such as the image 520 in the middle of FIG. 6 (an example of a “second display mode” in the claims), and the instruction to the terminal apparatus 110 of the player who is the first attacker is for displaying the other PP display region in a display mode such as the image 620 in the middle of FIG. 7. At this time, the server apparatus 120 updates the status or the like set in advance so as to record that the extra PP is in a used state, for example, so as to indicate the use state of the extra PP. The server apparatus 120 determines whether the extra PP is in a usable state, which is a previous-stage process of S901, based on the status.

Then, in S904, the server apparatus 120 determines whether a second operation (operation of canceling the use of the right specific to the second attacker) has been received via the terminal apparatus 110 of the second attacker. In S904, when it is determined that the second operation has been received, the processing returns to S901. On the other hand, in S904, when it is determined that the second operation has not been received, the processing proceeds to S905. At this time, the server apparatus 120 updates the status and the like so as to record that the extra PP is in a usable state (essentially in an unused state).

Then, in S905, the server apparatus 120 determines whether a predetermined condition that makes the game effect unable to be canceled is satisfied. As described above, the predetermined condition corresponds to, for example, a case where one or more PPs are consumed in response to the operation of a piece of game content, a case where the end turn button is pressed in a state where the game effect according to the use of the right granted to the second attacker has been generated, or the like. In S905, when it is determined that the predetermined condition is not satisfied, the processing returns to S904. On the other hand, in S905, when it is determined that the predetermined condition is satisfied, the processing proceeds to S906.

Then, in S906, the server apparatus 120 outputs an instruction to the terminal apparatus 110 to display the PP display region in a third display mode. The instruction to the terminal apparatus 110 of the second attacker is for changing the own PP display region displayed in a display mode such as the image 520 in the middle of FIG. 6 to a display mode indicating that the game effect based on the second attacker right cannot be canceled (an example of a “third display mode” in the claims, for example, a mode in which the use second attacker right button indicated by the image 525 cannot be pressed and the display of the region 525A in the image 525 disappears), and the instruction to the terminal apparatus 110 of the first attacker is for displaying the other PP display region in a display mode indicating that the opponent cannot cancel the game effect based on the right. At this time, the server apparatus 120 may execute processing of deleting the right to use the extra PP granted to the player (or, for example, processing of updating the status to “used” and setting a parameter relating to the right to use the extra PP of the player to a value indicating that the extra PP is not usable).

In the embodiment, when the end turn button is pressed after the processing of S904, the server apparatus 120 may output an instruction to display the own PP display region in a display mode such as the image 530 on the right side of FIG. 6 (that is, not to display the use second attacker right button) to the terminal apparatus 110 of the second attacker and output an instruction to display the other PP display region in a display mode such as the image 620 on the lower side of FIG. 7 to the terminal apparatus 110 of the first attacker. In this manner, PP management for the respective players by the server apparatus 120 is executed.

As described above, the system according to the embodiment is a system for providing a battle game in which a plurality of players each battle in a turn-based battle using a deck including a plurality of pieces of game content and is configured to determine a play order of the plurality of players in the battle game; grant, to a first player with a first play order, a right to generate a game effect for causing the battle to progress more advantageously than a second player with a second play order before the first play order; generate the game effect in response to a first operation of the first player; and cancel generation of the game effect in accordance with the first operation in response to a second operation of the first player. According to such a configuration, by granting the right in accordance with the play order, the advantage/disadvantage depending on being first or second in the play order can be reduced, and thus, the enjoyment of the battle game can be further improved.

The system according to the embodiment is configured to give one or more pieces of initial game content that is playable from the plurality of pieces of game content included in the deck to each of the first player and the second player at the start of the battle and grant a right that is not associated with the initial game content to the first player after the initial game content is given. According to such a configuration, the right can be granted at an appropriate timing at the start of the battle.

The system according to the embodiment is configured to display, on the first player side, a first image (own PP display region) indicating the state of the right. According to such a configuration, the first player can easily confirm the state of the right granted to the first player via the first image.

The system according to the embodiment is configured to be able to display, on the second player side, a second image (other PP display region) indicating the state of the right granted to the first player. According to such a configuration, the state of the right granted to the opponent can be easily confirmed via the second image.

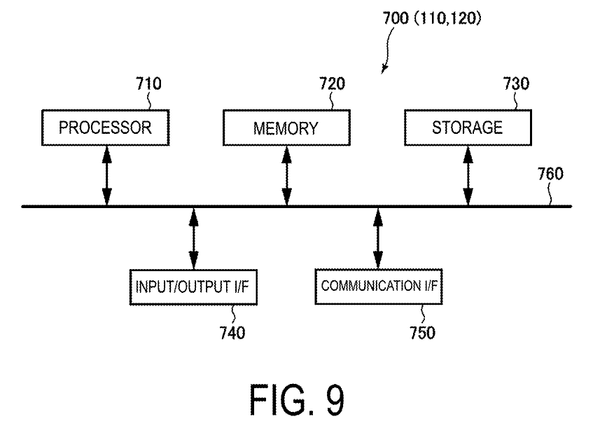

Finally, hardware configurations of the terminal apparatus 110 and the server apparatus 120 according to the above-described embodiments will be described. The terminal apparatuses 110 and the server apparatus 120 according to the embodiment are configured as an information processing apparatus 700 having a hardware configuration similar to that of a general-purpose computer, for example, as illustrated in FIG. 9.

FIG. 9 is an exemplary and schematic block diagram illustrating the hardware configuration of the information processing apparatus 700 configuring the terminal apparatus 110 and the server apparatus 120 according to the embodiment.

As illustrated in FIG. 9, the information processing apparatus 700 includes a processor 710, a memory 720, a storage 730, an input/output interface (I/F) 740, and a communication interface (I/F) 750. These hardware components are connected to a bus 760.

The processor 710 is configured as, for example, a central processing unit (CPU), and comprehensively controls an operation of each unit of the information processing apparatus 1300.

The memory 720 includes, for example, a read only memory (ROM) and a random access memory (RAM) and achieves volatile or non-volatile storage of various types of data such as a program to be executed by the processor 710, provision of a work region for the processor 710 to execute the program, and the like.

The storage 730 includes, for example, a hard disk drive (HDD) or a solid state drive (SSD) and stores various types of data in a non-volatile manner.

The input/output interface 740 controls, for example, input of data from an input apparatus (input unit) such as a pointing device such as a touch panel or a mouse, a game controller, a keyboard, a microphone, GPS, and various sensors (an acceleration sensor, an optical sensor, a pressure sensor, an atmospheric pressure sensor, and the like) to the information processing apparatus 700 and output of data from the information processing apparatus 700 to an output apparatus (output unit) such as a display (display apparatus), a speaker (acoustic apparatus), and an actuator (a driving apparatus for providing feedback such as vibration or a tactile sensation to the user).

The communication interface 750 enables the information processing apparatus 700 to communicate with other apparatuses.

The functional configuration of the terminal apparatus 110 according to the embodiment (see FIG. 2) is implemented as a functional module group by cooperation of hardware and software as a result of the processor 710 executing the program stored in advance in the memory 720 or the storage 730. However, in the embodiment, one or some, or all of units included in the functional module group illustrated in FIG. 2 may be implemented only by hardware such as circuitry exclusively designed. Further, in the embodiment, at least one or some of the units included in the functional module group illustrated in FIG. 2 may be implemented on the server apparatus 120 side.

Note that the above-described program does not necessarily need to be stored in advance in the memory 1220 or the storage 1230. For example, the above-described program may be provided as a computer program product recorded in an installable format or an executable format on a computer-readable medium such as various magnetic disks such as a flexible disk (FD) or various optical disks such as a digital versatile disk (DVD).

Further, the program described above may be provided or distributed via a network such as the Internet. That is, the above-described program may be provided, in a state of being stored in a computer connected to a network such as the Internet, by being downloaded via the network.

Although the embodiments of the present disclosure have been described above, the embodiments are presented as examples and are not intended to limit the scope of the invention. The novel embodiments described herein may be embodied in a variety of other forms; furthermore, various omissions, substitutions, and changes in the forms of the embodiments and modified examples described herein may be made without departing from the gist of the invention. These embodiments and modifications are included in the scope or the gist of the invention and are included in the invention described in the claims and the scope of equivalents thereof.

### REFERENCE SIGNS LIST

110 Terminal apparatus
120 Server apparatus
201 Reception processing unit
202 Management processing unit
203 Game control processing unit
204 Display processing unit

1. A non-transitory computer readable medium storing a program for providing a battle game in which a plurality of players each battle in a turn-based battle using a deck including a plurality of pieces of game content, the program causing at least one computer to execute:
determining a play order of the plurality of players in the battle game;
granting, to a first player with a first play order, a right to generate a game effect for causing the battle to progress more advantageously than a second player with a second play order before the first play order;
generating a game effect in response to a first operation of the first player; and
canceling generation of the game effect in accordance with the first operation in response to a second operation of the first player.

2. The non-transitory computer readable medium according to claim 1, wherein the program further causes the at least one computer to execute:
giving one or more pieces of initial game content that is playable from the plurality of pieces of game content included in the deck to each of the first player and the second player at a start of the battle; and
granting the right that is not associated with the initial game content to the first player after the initial game content is given.

3. The non-transitory computer readable medium according to claim 1, wherein the program further causes the at least one computer to execute:
displaying, on the first player side, a first image indicating a state of the right.

4. The non-transitory computer readable medium according to claim 3, wherein the program further causes the at least one computer to execute:
in a case where the right has been granted, displaying the first image in a first display mode that allows the first operation to be received; and
in a case where the first operation is received via the first image, changing a display mode of the first image from the first display mode to a second display mode that allows the second operation to be received.

5. The non-transitory computer readable medium according to claim 4, wherein the program further causes the at least one computer to execute:
in a case where the second operation is received via the first image displayed in the second display mode, changing the display mode of the first image from the second display mode to the first display mode; and
in a case where a predetermined condition that makes the game effect unable to be canceled is satisfied in a state in which the first image is displayed in the second display mode, changing the display mode of the first image from the second display mode to a third display mode that indicates that the game effect is not allowed to be canceled.

6. The non-transitory computer readable medium according to claim 4, wherein
the second display mode is a display mode that allows the first player to be notified, via the second operation, that generation of the game effect is allowed to be canceled.

7. The non-transitory computer readable medium according to claim 1, the program further causes the at least one computer to execute:
displaying, on the second player side, a second image indicating a state of the right granted to the first player.

8. The non-transitory computer readable medium according to claim 7, wherein the program further causes the at least one computer to execute:
displaying the second image in a display mode that allows identification of whether the game effect has been generated by the first player.

9. The non-transitory computer readable medium according to claim 1, wherein
the game effect is an effect of increasing points that are set per turn so as to decrease in accordance with the game content being played in the battle.

10. A method executed by at least one computer of providing a battle game in which a plurality of players each battle in a turn-based battle using a deck including a plurality of pieces of game content, the method comprising:
determining a play order of the plurality of players in the battle game;
granting, to a first player with a first play order, a right to generate a game effect for causing the battle to progress more advantageously than a second player with a second play order before the first play order;
generating a game effect in response to a first operation of the first player; and
canceling generation of the game effect in accordance with the first operation in response to a second operation of the first player.

11. A system for providing a battle game in which a plurality of players each battle in a turn-based battle using a deck including a plurality of pieces of game content, the system being configured to:
determine a play order of the plurality of players in the battle game;
grant, to a first player with a first play order, a right to generate a game effect for causing the battle to progress more advantageously than a second player with a second play order before the first play order;
generate a game effect in response to a first operation of the first player; and
cancel generation of the game effect in accordance with the first operation in response to a second operation of the first player.
